(19) United States
(12) Patent Application Publication
(10) Pub. No.: US 2021/0161759 A1
(43) Pub. Date: Jun. 3, 2021

(54) EXTENSION ARM ATTACHMENT FOR A MASSAGER APPARATUS

(71) Applicant: Fitness Evolution 808 LLC, Honolulu, HI (US)

(72) Inventor: Michael Minkus, Honolulu, HI (US)

(21) Appl. No.: 17/111,434

(22) Filed: Dec. 3, 2020

Related U.S. Application Data
(60) Provisional application No. 62/943,125, filed on Dec. 3, 2019.

(51) Int. Cl. A61H 37/00; A61H 23/00

(52) U.S. Cl. CPC A61H 37/00; A61H 23/00; A61H 2201/0153; A61H 2201/0107; A61H 2201/0157; A61H 2201/0192; A61H 2201/0165

(57) ABSTRACT

Various embodiments of an extension arm attachment configured for coupling with a portable massager apparatus are disclosed.

This is a non-provisional application that claims benefit to U.S. provisional application Ser. No. 62/943,125 filed on Dec. 3, 2019, which is herein incorporated by reference in its entirety.

### FIELD

The present disclosure generally relates to extension arms for portable devices, and in particular to an extension arm attachment configured for engaging a portable “T”-style hand-held massager device.

### BACKGROUND

Portable hand-held massager devices, such as “T”-style hand-held percussion massager devices, are well known for providing rehabilitative and therapeutic massaging effects to a user. Typically, these types of portable massager devices are held by the hand and manipulated by the user to massage particular portions of the body; however, areas of the body, such the back, are difficult to reach and directly apply the portable massager. As such, portable hand-held massager devices lack a means for allowing a user to contact those hard-to-reach areas of the body, such as the upper and lower back areas.

It is with these observations in mind, among others, that various aspects of the present disclosure were conceived and developed.

### BRIEF DESCRIPTIONS OF THE DRAWINGS

FIG. 1 is a side view of the extension arm attachment engaged with a conventional portable massager device.

FIG. 2 is an enlarged perspective view of the extension arm attachment engaged to the conventional portable massager device of FIG. 1.

FIG. 3 is an exploded view of the extension arm attachment of FIG. 1 showing an extension arm, coupling member, hand grip, and plastic end cover.

FIG. 4 is an enlarged view of the coupling member engaged to the extension arm without the clamping member.

FIG. 5 is a perspective view of the extension arm attachment of FIG. 1.

FIG. 6 is a side view of the extension arm attachment of FIG. 1.

FIG. 7 is a proximal end view of the extension arm attachment of FIG. 1.

FIG. 8 is a distal end view of the extension arm attachment showing the inner channel and inner shoulder configured to receive and engage a handle of the conventional portable massager device of FIG. 1.

Corresponding reference characters indicate corresponding elements among the view of the drawings. The headings used in the figures do not limit the scope of the claims.

### DETAILED DESCRIPTION

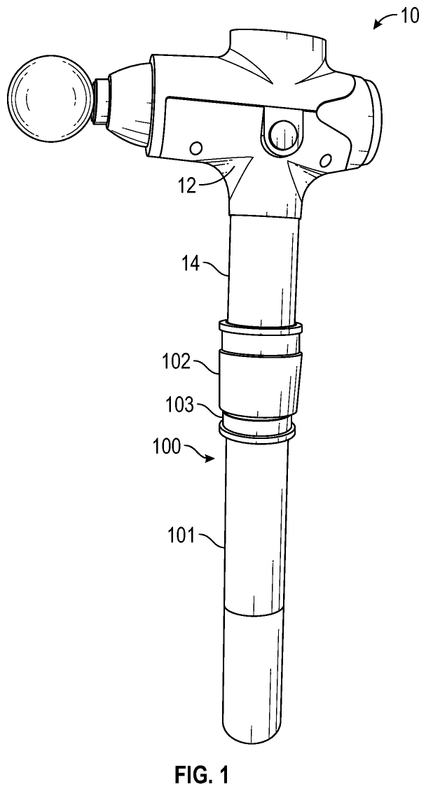

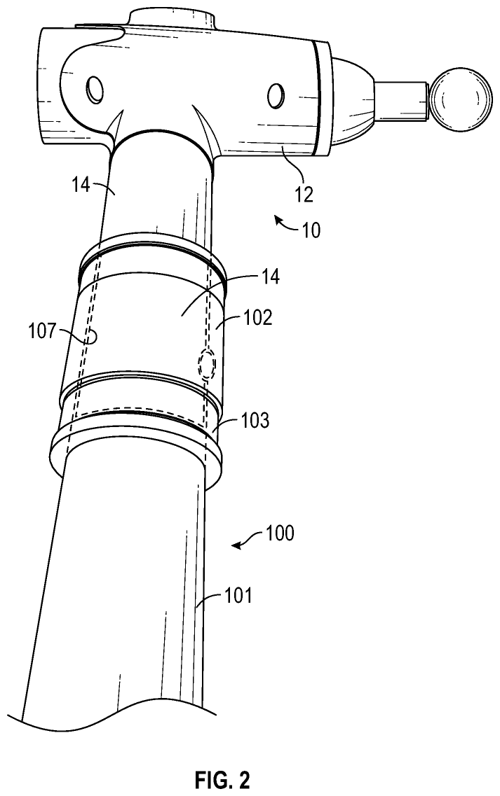

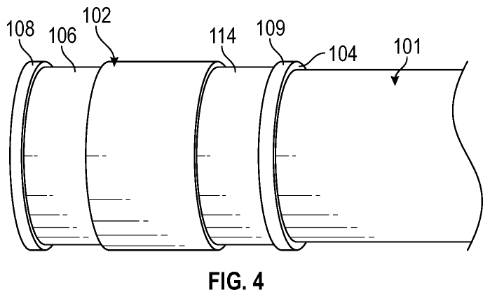

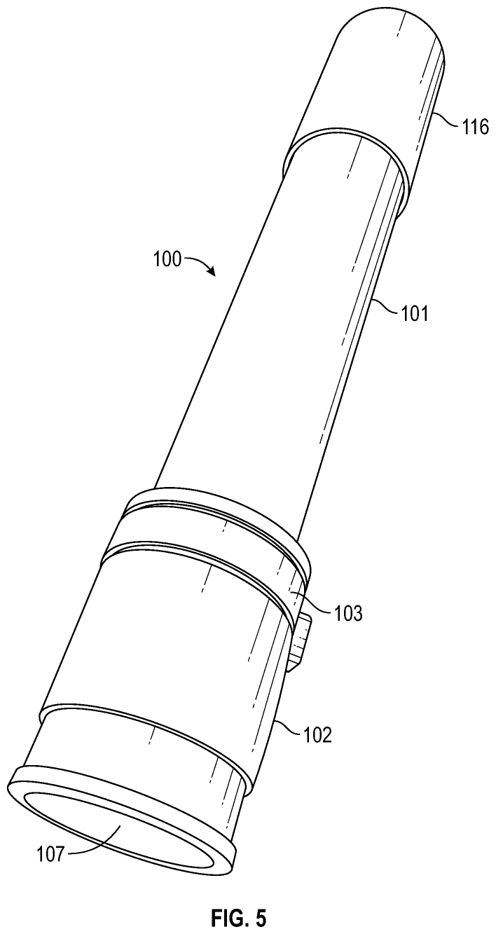

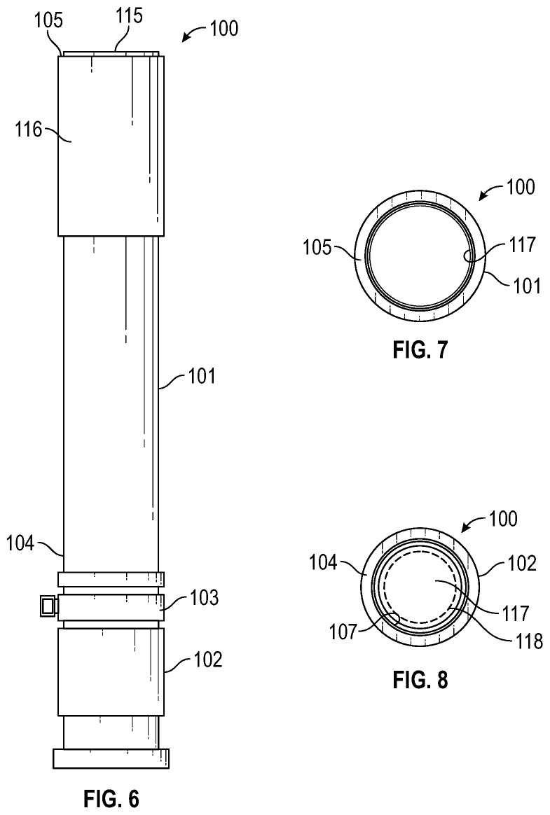

Various embodiments of an extension arm attachment configured for securely mounting a portable massager device, such as a “T”-style portable massager devices, that extends the reach of the portable massager device such the user can reach previously inaccessible areas of the body with the portable massager device due to the additional extension provided by the extension arm attachment when mounted to the portable massager device. In some embodiments, the extension arm attachment includes an extension arm forming an elongated body coupled with a coupling member mounted to one end of the extension arm. In one aspect, the coupling member defines an inner channel configured to receive the handle of a portable massager device and collectively forms an inner shoulder with the extension arm to define a mounting surface for mounting the portable massager device to the inner channel of the coupling member. In some embodiments, a cable tie is provided to securely mount the portable massager device to the extension arm. Referring to the drawings, an embodiment of an extension arm attachment for coupling with a massager apparatus is illustrated and generally indicated as 100 in FIGS. 1-8.

Referring to FIGS. 1-4, an embodiment of the extension arm attachment, designated 100, is illustrated. As shown, the extension arm attachment 100 includes a hollow, tubular-shaped extension arm 101 configured to securely engage a coupling member 102. In some embodiments, the extension arm 101 and coupling member 102 are made from an ABS material that allow a cable tie 103 to securely couple the attachment arm 101 to the coupling member 102. In one method of assembly, the attachment arm 101 is received within the coupling member 102 such that the attachment arm 101 extends a distance within the coupling member 102. In some embodiments, a band 111 of a cable tie 103 may be tightened around groove 114 of the coupling member 102 by inserting the band 111 through a housing 110 that engages serrations (not shown) formed along one side of the band 111 until the band 111 produces a compressive force around the coupling member 102 such that the coupling member 102 cannot be disengaged from the extension arm 101. In some embodiments, the cable tie 103 may be tightened around the coupling member 102 either by hand or by machine. In some embodiments, the extension arm 101 and coupling member 102 may be manufactured as a single unitary construct without requiring prior assembly during manufacture.

Referring back to FIG. 1, as noted above the extension arm attachment 100 is configured to be coupled with a conventional portable massager apparatus 10, for example, a “T”-style portable percussion massager apparatus; however, any portable massager apparatus with a suitable handle may be coupled to the extension arm attachment. The extension arm attachment 100 is configured to be coupled with the handle 14 of the portable massager apparatus 10. In one method of assembling the portable massager apparatus 10 to the extension arm attachment 100, the handle 14 may be partially disposed within the coupling member 102 such that the rubberized grip of the portable massager apparatus 10 is either partially or fully disposed within the coupling member 102. In some embodiments of the portable massager apparatus 10, remains exposed and only the free end of the handle 14 is engaged with the coupling member 101, while in other methods of assembly the handle 14 is fully disposed within the coupling member 102 of the extension arm attachment 100. In either case, a user will be able to grip the handle 14 and operate the portable massager apparatus 10 under normal use once the extension arm attachment 100 is connected.

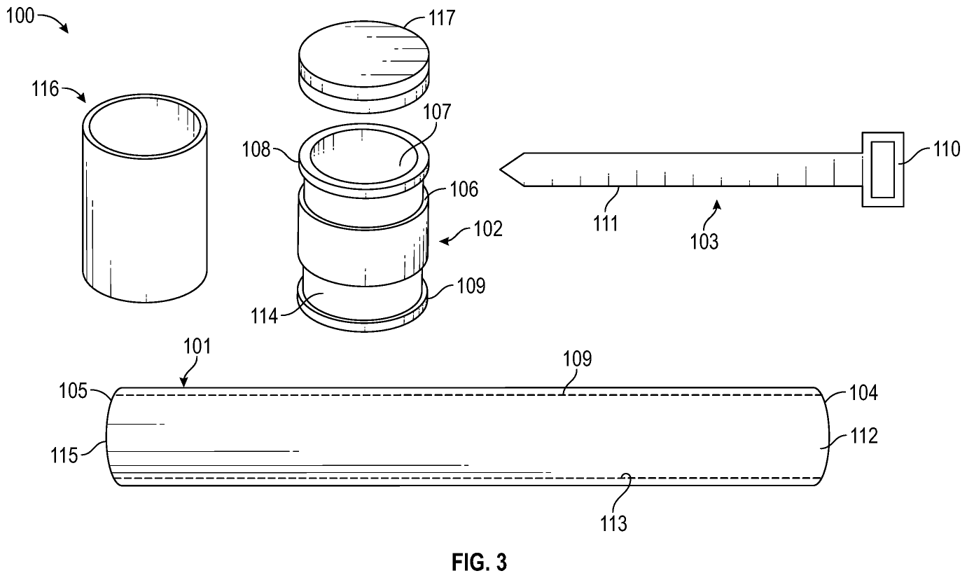

Referring to FIG. 3, the extension arm 101 forms an elongated tubular-shaped body forming a distal end portion 104 configured for mounting the coupling member 102 with the portable massager apparatus 10 and an opposite proximal end portion 105 configured to be used as a gripping surface 116. As further shown, an end cap 117 seals off the proximal opening 115 of the extension arm 101. The extension arm 101 defines a distal opening 112 formed at the distal end 104 of the extension arm 101 that communicates with an inner channel 113 that extends the length of the extension arm 101.

As shown in FIG. 3, the coupling member 102 forms a body 106 defining a distal end 108 and an opposing proximal end 109 with an axial channel 107 formed between and in communication with a distal end 108 and a proximal ends 109, respectively. In some embodiments, the coupling member 102 may be attached or formed integral with the distal end portion 104 of the extension arm 101. Once engaged to the extension arm 101, the coupling member 102 is configured to receive the handle 14 of the portable massager apparatus 10 such that the portable massager apparatus 10 is securely mounted to the coupling member 102 of the extension arm attachment 100. In one aspect, the body 106 of the coupling member 102 defines a shallow circumferential groove 114 configured to receive the clamping tie 103 for tightening and securing the distal end 104 of the extension arm 101 to the proximal end 109 of the coupling member 102. In another aspect, the handle 14 of the portable massager apparatus 10 may be configured to house a conventional lithium ion battery which engages the coupling member 102 in which the friction and suction between the rubber material of the coupling member 102 and the handle 14 is sufficient to hold the extension arm attachment 100 to the portable massager apparatus 10 securely together.

In some embodiments, a flexible retention band, such as a flexible band made from VELCRO, may be engaged around the portable massager apparatus 10 for further securing the portable massager apparatus 10 with the extension arm attachment 100. In some embodiments, a gripping handle may be a padded hand grip 116 engaged along the extension arm 101 along the proximal end portion 105 for providing a gripping surface for the user when handling the extension arm attachment 100.

In one aspect, engagement of the extension arm attachment 100 to the portable massager device 10 decreases the degree of vibration felt by the user handling the extension arm 101 due to the coupling member 102 and the addition of the padded hand grip 116.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. An extension arm attachment configured to engage a portable massager device comprising:
an extension arm having an elongated body forming a proximal end portion and a distal end portion with a distal opening defined at the distal end portion thereof, and an inner channel formed between the distal end portion and proximal end portion of the elongated body; and
a coupling member engaged to the distal end portion of the extension arm, the coupling member having a tubular body forming a proximal end and a distal end with the a distal opening defined at the distal end thereof in communication with an interior channel that is in communication with the inner channel of the extension arm.

2. The extension arm attachment of claim 1, wherein the distal end portion of the extension arm is in co-axial relation with the coupling member when the extension arm is engaged with the coupling member.

3. The extension arm attachment of claim 1, wherein the coupling member defines an interior channel configured to receive a handle of the portable massager apparatus for mounting the portable massager apparatus to the extension arm.

4. The extension arm attachment of claim 3, wherein the extension arm decreases the degree of vibration when the portable massager device is in operation.

5. The extension arm attachment of claim 1, further comprising:
a clamping tie engaged around the coupling member for securing the coupling member to the extension arm.

6. The extension arm attachment of claim 1, wherein the distal end portion of the extension arm forms an inner shoulder with the interior channel of the coupling member when the extension arm is engaged to the coupling member.

7. The extension arm attachment of claim 1, wherein the proximal end portion includes a padded hand grip.

8. The extension arm attachment of claim 1, wherein the proximal opening of the extension arm is sealed with an end cap.

9. The extension arm attachment of claim 1, wherein the coupling member is made from a rubber material.

10. A method of assembling an extension arm attachment comprising:
providing an extension arm defining an elongated body forming a proximal end portion and a distal end portion with a distal opening defined at the distal end portion thereof and a proximal opening formed at the proximal end portion thereof, and an inner channel formed between the distal opening and proximal opening of the elongated body;
providing a coupling member defining a tubular body forming a proximal end and a distal end with the a distal opening defined at the distal end thereof and a proximal opening defined at the proximal end and an interior channel formed between the distal opening and the proximal opening; and
coupling the distal end portion of the extension arm through the proximal opening of the coupling member such that an inner shoulder is formed by the distal end portion of the extension arm within the interior channel of the coupling member.

11. The method of claim 10, wherein the coupling member is engaged to the distal end portion of the extension arm.

12. The method of claim 10, wherein the interior channel of the coupling member is configured to receive a handle of a portable massager apparatus.

13. The method of claim 10, wherein the coupling member is made from a rubber material that produces a friction fit and suction when the handle of the portable massager apparatus is received within the interior channel of the coupling member.

14. The method of claim 10, further comprising:
engaging a tightening clamp around the coupling member to further engage the coupling member to the extension arm.
